(19) United States
(12) Patent Application Publication
(10) Pub. No.: US 2006/0011654 A1
(43) Pub. Date: Jan. 19, 2006

(54) Disinfectant cap for sterile liquid dispenser

(76) Inventor: Garth T. Webb, White Rock (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 10/892,093

(22) Filed: Jul. 16, 2004

(51) Int. Cl. B67D 5/58

(52) U.S. Cl. 222/189.06

(57) ABSTRACT

A disinfectant cap for sterile liquid dispensers is disclosed. The cap for a dispenser for sterile liquid having a hollow container for storing the sterile liquid and a dispensing end having an outlet port, wherein the cap comprises a biocide-retaining element secured to the inner surface of the cap and is configured to contact the outlet port of the dispenser when in the closed position.

### TECHNICAL FIELD

The invention relates to the field of dispensers for sterile liquids.

### BACKGROUND

Various ophthalmic and medical applications require a hand-held dispenser of multiple doses of sterile liquids. Sterile saline is required by contact lens wearers for use as a rinse solution, for rinsing the lens prior to inserting the lens in the eye, and also for soaking the lens during the cleaning and disinfecting process. Dispensers have been designed to maintain such liquids in a sterile state for dispensing, such as disclosed in the present inventor's U.S. Pat. No. 5,507,417, which discloses a dispenser for sterile saline solution and U.S. Pat. No. 6,745,763 which discloses a vaporizing device for administering sterile medication. Similarly, dispensers of medicinal liquids for eye, ear and nose drops desirably keep such liquids sterile between uses to prevent bacterial growth. An example of such device is disclosed in U.S. Pat. No. 4,533,068 Meierhoefer, wherein a hydrophobic filter is used to sterilize the replacement air which enters the dispenser upon release of the squeezing pressure. Other devices use an antibacterial hydrophobic filter over the outlet port, or hydrophobic and hydrophilic filters in tandem, to maintain the liquid sterile. See U.S. Pat. No. 3,149,758 Bush et al.; U.S. Pat. No. 4,938,389 Rossi et al. and Kramer et al. U.S. Pat. No. 4,463,880.

Commonly such dispensers use a one-way valve or pump with a one-way valve to dispense the sterile liquid from a squeeze bottle or collapsible reservoir. A problem with existing devices is that after the sterile liquid is dispensed, some residue remains on the outlet port, or is drawn back into the outlet conduit, which can become contaminated with bacteria or the like and which will contaminate the next dose of the sterile liquid which is dispensed through the outlet port. There is therefore a need to avoid the foregoing problem with sterile liquid dispensers.

### SUMMARY OF INVENTION

The present invention provides a disinfectant cap for sterile liquid dispensers. The invention provides a cap for a dispenser for sterile liquid having a hollow container for storing the sterile liquid and a dispensing end having an outlet port, wherein the cap comprises a biocide-retaining element secured to the inner surface of the cap and is configured to contact the outlet port of the dispenser when in the closed position.

### BRIEF DESCRIPTION OF DRAWINGS

In drawings which disclose a preferred embodiment of the invention:

FIG. 1 is a vertical cross section of a first embodiment of the invention with cap in the closed position;

FIG. 2 is a vertical cross section of a second embodiment of the invention with cap in the open position;

FIG. 3 is a vertical cross section of a third embodiment of the invention with cap in the closed position; and

FIG. 4 is a vertical cross section of a fourth embodiment of the invention with cap in the closed position.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

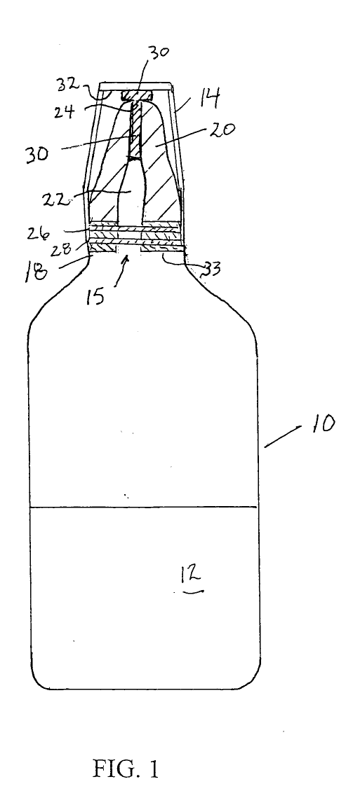

With reference to FIG. 1, a hollow container 10 contains sterile liquid 12. Typically the container 10 will be constructed of a flexible plastic such as polyethylene to permit squeezing or collapse of the container. Cap 14 is preferably formed of a rigid plastic material. Cap 14 is sized to provide a friction or snap fit, or threaded connection over neck 18 of container 10. Container 10 has a liquid-dispensing tip 20 having a central outlet conduit 22 communicating with outlet opening 24. Sterile liquid is dispensed by inverting and squeezing the container 10.

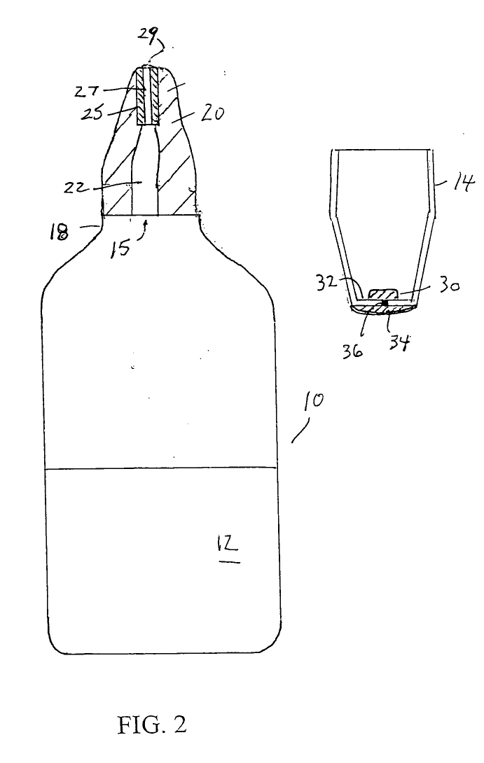

The interior of container 10 communicates with outlet conduit 22 via communication port 15. To preserve the sterility of sterile liquid 12 when the liquid is dispensed from container 12 such as by squeezing the container, a filter assembly comprising hydrophobic filter 26, hydrophilic filter 28 and support discs 33 is provided across the liquid passage from port 15 to outlet 24. Filters of the type disclosed in U.S. Pat. No. 4,938,389 are suitable or other suitable microporous filters known in the art. Cap 14 is also provided with a biocide-containing pad 30 which is fixed to the upper inner surface 32 of cap 14 by adhesive or the like. The pad 30 may be a biocidal-powder impregnated pad or may be formed of absorbent material such as sponge or absorbent cotton material which soaks up a concentrated liquid biocide stored in hollow cavity 34 in cap 14 and wicked to pad 30 by wick 36 (see FIG. 2). In the embodiment shown in FIG. 1, preferably pad 30 extends partly or completely down conduit 22.

FIG. 2 illustrates a second embodiment of the invention wherein a one-way valve 25 prevents the egress of contaminants into the squeeze bottle 10. Valve 25 has a conduit 27 and a small hole 29 at the dispensing port formed in a rubber material under tension whereby the hole is normally closed but opens when pressure increases in conduit 27. By squeezing bottle 10, sterile liquid 12 is forced into conduit 27, hole 29 opens and the liquid 12 is dispensed. When cap 14 is replaced, pad 30 completely covers the dispensing tip 29 to sterilize any remaining liquid on the exterior. Container 10 remains collapsed after liquid is dispensed as no air is permitted back into the container.

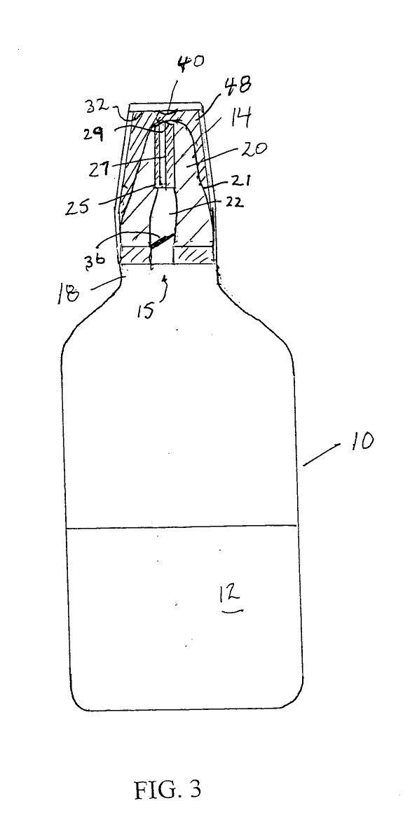

An alternate form of biocidal pad is indicated at 48 in FIG. 3. In this case the pad is resilient and conical in shape to conform to fill the space between surface 21 of the tip 20 and the inner surface 32 of cap 14. The inner surface 32 of cap 14 may have an inwardly projecting bump or thickening 40 in the region of the hole 29 in order to compress the pad 48 against the tip 20 in that region. Again pad 48 can be either impregnated with a biocidal powder, or liquid-absorbent and wicked to a supply of concentrated liquid biocide. In this embodiment a one-way valve 25 is provided again, with dispensing hole 29. A secondary hinged one-way valve 36 is provided made of a resilient rubber material or the like. Tip 20 is formed of a squeezable material such as rubber. Sterile liquid 12 flows into chamber 22 such as by inverting container 10. By squeezing tip 20 the valve 36 closes and liquid is forced through dispensing hole 29. After dispensing, cap 14 is replaced so that pad 48 is compressed against the tip in the region of hole 29, thereby placing biocide in contact with the entire surface 21 of tip 20. By forming pad 48 of compressible sponge material, the pad may expand when the cap is removed and when screwed into position will scour the surface 21 in the region of hole 29 as well as the entire tip 20.

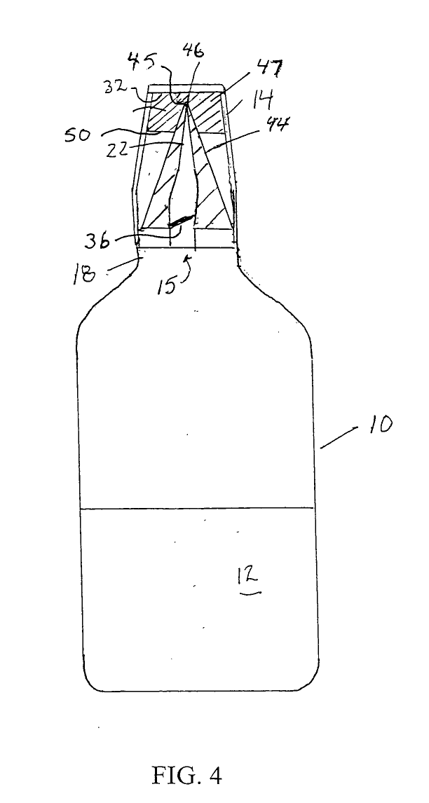

A further alternate form of disinfectant cap 14 is shown in FIG. 4. In this case the tip 44 has a sharp conical outlet end 46 and one-way valve 45. A body of biocide 47, such as a gel or liquid, is retained by membrane 50 in the upper portion of cap 14. When cap 14 is closed, the end 46 pierces a central opening in membrane 50 and is immersed in the gel biocide 47. Membrane 50 is formed of rubber or the like so that when end 46 is withdrawn from the central hole the hole is closed by surface tension to retain the biocide gel within the membrane.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A cap for a dispenser for sterile liquid having a hollow container for storing said sterile liquid and a dispensing end having an outlet port, said cap comprising a biocide-retaining element secured to the inner surface of said cap and configured to contact the outlet port of said dispenser when in the closed position.

2. The cap of claim 1 wherein said biocide-retaining element comprises an absorbent material.

3. The cap of claim 2 further comprising a reservoir for storing biocide and wherein said reservoir communicates with said biocide-retaining element.

4. The cap of claim 2 wherein said biocide-retaining element comprises a sponge material.

5. The cap of claim 1 wherein said biocide-retaining element extends into said outlet port when said cap is in the closed position.

6. The cap of claim 1 wherein said biocide-retaining element comprises a solid biocide.

7. The cap of claim 6 wherein said solid biocide is a powder.

8. The cap of claim 1 wherein said biocide-retaining element comprises a liquid biocide.

9. The cap of claim 1 wherein said biocide-retaining element comprises a semi-liquid biocide.

10. The cap of claim 1 wherein said biocide-retaining element comprises a gel biocide.

11. The cap of claim 1 wherein said biocide-retaining element comprises a liquid-retaining membrane.

12. A dispenser for sterile liquid comprising a hollow container for storing said sterile liquid, a dispensing end having an outlet port and a cap comprising a biocide-retaining element secured to the inner surface of said cap and configured to contact the outlet port of said dispenser when in the closed position.

13. The dispenser of claim 12 wherein said biocide-retaining element comprises an absorbent material.

14. The dispenser of claim 13 further comprising a reservoir for storing biocide and wherein said reservoir communicates with said biocide-retaining element.

15. The dispenser of claim 13 wherein said biocide-retaining element comprises a sponge material.

16. The dispenser of claim 12 wherein said biocide-retaining element extends into said outlet port when said cap is in the closed position.

17. The dispenser of claim 12 wherein said biocide-retaining element comprises a solid biocide.

18. The dispenser of claim 17 wherein said solid biocide is a powder.

19. The dispenser of claim 12 wherein said biocide-retaining element comprises a liquid biocide.

20. The dispenser of claim 12 wherein said biocide-retaining element comprises a semi-liquid biocide.

21. The dispenser of claim 12 wherein said biocide-retaining element comprises a gel biocide.

22. The dispenser of claim 12 wherein said biocide-retaining element comprises a liquid-retaining membrane.
